(19) United States
(12) Patent Application Publication
(10) Pub. No.: US 2009/0084289 A1
(43) Pub. Date: Apr. 2, 2009

(54) Lime Independent Cementitious Mixtures

(76) Inventor: Malcolm Dawson, Queensland (AU)

Correspondence Address: ABELMAN, FRAYNE & SCHWAB, 666 THIRD AVENUE, 10TH FLOOR, NEW YORK, NY, 10017, US

(21) Appl. No.: 11/990,466

(22) PCT Filed: Aug. 11, 2006
(86) PCT No.: PCT/AU2006/001155

§ 371 Date: Feb. 12, 2008

(30) Foreign Application Priority Data
Aug. 12, 2005 (AU) 2005904370

(51) Int. Cl. C04B 9/06

(52) U.S. Cl. 106/683

(57) ABSTRACT

A lime independent cementitious mixture including: an iron oxides constituent comprising one or more oxides of iron; and an activator. The activator is selected from one or more metal non-chloride salts, including metal phosphates and nitrates, or non-alkaline earth metal salts. The activator is also selected from those which may form one or more megalithic molecules with the iron oxides constituent when co-activated with water. A lime independent cementitious mixture including an iron oxides constituent comprising one or more oxides of iron; a silicates constituent comprising one or more calcined metal silicates; and an activator selected from one or more metal non-chloride salts which may form one or more megalithic molecules with the iron oxides and/or silicates constituents when co-activated with water.

### FIELD OF INVENTION

THIS INVENTION relates lime independent cementitious mixtures and to a method of forming concrete which is not reliant upon the inclusion of calcined lime.

The present invention has particular application to substantially lime-free cementitious mixtures for use in applications in which lime-based cementitious mixtures have a tendency to corrode. The invention also relates to cementitious mixtures in respect of which the contribution of the set cementitious mixture to the corrosion of iron-based reinforcing elements embedded in the concrete is substantially ameliorated.

In the art, the terms “cement” and “concrete” are used somewhat loosely. In this specification, unless the context requires otherwise, the term “cement” is used to refer to the powdered constituents when mixed together prior to being activated to form concrete. Unless the context requires otherwise, the term “concrete” is used to refer to a composite material including cement after the addition of water to make it set as well as the material once it has set. Concrete normally also includes aggregate and cement binder to blended with water to form a composite material.

### BACKGROUND ART

Cementitious mixtures traditionally include calcined lime and/or other similar pozzolanic material for binding of or with other constituents to form concrete. Portland cement is a particularly common cement used to make structural concrete which is normally reinforced. Lime is a very common constituent in cement, Portland cement being typically formed from limestone, clay and gypsum. However, notwithstanding that gypsum is a sulfur compound, lime in concrete may be attacked by sulfur or sulfurous materials. As a result, in some environments, the presence of calcined lime may adversely affect the structural integrity of concretes having calcined lime in their formulations.

Traditional cementitious mixtures involve compounds of alkaline earth metals. Lime has long been used, and a magnesia cement has been proposed for use in the agglomeration, aggregation, hardening and moulding of mineral, vegetable or animal substances by means of magnesium oxychloride. A later development is a proposal to blend magnesia with a metallic oxide and phosphate. However, the only oxides suggested are those of iron.

The present invention aims to provide lime independent cementitious mixtures, and a method of forming concrete from cementitious mixtures substantially free of calcined lime which alleviate at least one of the abovementioned problems of the prior art. Other aims and advantages of the invention may become apparent from the following description.

### DISCLOSURE OF THE INVENTION

With the foregoing in view, the present invention in one aspect resides broadly in a lime independent cementitious mixture including:

an iron oxides constituent comprising one or more oxides of iron; and

an activator selected from one or more metal non-chloride salts which may form one or more megalithic molecules with the iron oxides constituent when co-activated with water.

In another aspect, the present invention resides broadly in a lime independent cementitious mixture including:

an iron oxides constituent comprising one or more oxides of iron; and

an activator selected from one or more metal phosphates which may form one or more megalithic molecules with the iron oxides constituent when co-activated with water.

In another aspect, the present invention resides broadly in a lime independent cementitious mixture including:

an iron oxides constituent comprising one or more oxides of iron; and

an activator selected from one or more metal nitrates which may form one or more megalithic molecules with the iron oxides constituent when co-activated with water.

In another aspect, the present invention resides broadly in a lime independent cementitious mixture including:

an iron oxides constituent comprising one or more oxides of iron; and

an activator selected from one or more non-alkaline earth metal salts which may form one or more megalithic molecules with the iron oxides constituent when co-activated with water.

In another aspect, the present invention resides broadly in a lime independent cementitious mixture including:

an iron oxides constituent comprising one or more oxides of iron;

an activator selected from one or more non-alkaline earth metal salts and one or more magnesium and/or aluminium non-chloride salts which may form one or more megalithic molecules with the iron oxides constituent when co-activated with water.

In another aspect, the present invention resides broadly in a lime independent cementitious mixture including:

an iron oxides constituent comprising one or more oxides of iron;

a silicates constituent comprising one or more calcined metal silicates; and

an activator selected from one or more metal salts which may form one or more megalithic molecules with the iron oxides and/or silicates constituents when co-activated with water.

In another aspect, the present invention resides broadly in a lime independent cementitious mixture including:

an iron oxides constituent comprising one or more oxides of iron;

a silicates constituent comprising one or more calcined metal silicates; and

an activator selected from one or more metal non-chloride salts which may form one or more megalithic molecules with the iron oxides and/or silicates constituents when co-activated with water.

In another aspect, the present invention resides broadly in a lime independent cementitious mixture including:

an iron oxides constituent comprising one or more oxides of iron;

a silicates constituent comprising one or more calcined metal silicates; and

an activator selected from one or more non-alkaline earth metal salts which may form one or more megalithic molecules with the iron oxides and/or silicates constituents when co-activated with water.

In another aspect, the present invention resides broadly in a lime independent cementitious mixture including:

an iron oxides constituent comprising one or more oxides of iron;

a silicates constituent comprising one or more calcined metal silicates; and

an activator selected from one or more non-alkaline earth metal salts and one or more magnesium and/or aluminium non-chloride salts which may form one or more megalithic molecules with the iron oxides and/or silicates constituents when co-activated with water.

Preferably, the iron oxides constituent is selected from iron ores including taconite, magnetite and hematite and from mill scale, mill rust, and red mud from bauxite. Preferably, the iron oxides constituent is calcined. Preferably, the iron oxides constituent comprises from 20% to 50% by weight of the mixture.

In another aspect, the present invention resides broadly in a lime independent cementitious mixture including:

a silicates constituent comprising one or more calcined metal silicates; and

an activator selected from one or more metal salts which may form one or more megalithic molecules with the silicates constituent when co-activated with water.

In another aspect, the present invention resides broadly in a lime independent cementitious mixture including:

a silicates constituent comprising one or more calcined metal silicates; and

an activator selected from one or more metal non-chloride salts which may form one or more megalithic molecules with the silicates constituent when co-activated with water.

In another aspect, the present invention resides broadly in a lime independent cementitious mixture including:

a silicates constituent comprising one or more calcined metal silicates; and

an activator selected from one or more non-alkaline earth metal salts which may form one or more megalithic molecules with the silicates constituent when co-activated with water.

In another aspect, the present invention resides broadly in a lime independent cementitious mixture including:

a silicates constituent comprising one or more calcined metal silicates; and

an activator selected from one or more non-alkaline earth metal salts and one or more magnesium and/or aluminium non-chloride salts which may form one or more megalithic molecules with silicates constituent when co-activated with water.

Preferably, the non-chloride salts are selected from magnesium and aluminium non-chloride salts. In such form, ammonium non-chloride salts may be included. Preferably, the silicates constituent includes meta zirconium silicate. Preferably, the silicates constituent includes magnesium aluminium silicates. Preferably, the mixture includes from 5% to 30% magnesium carbonates and oxides (with or without a calcium component) with 10% to 60% aluminium oxides. Preferably, the mixture includes a silicates constituent as hereinbefore described and comprising from 10% to 30% meta zirconium silicate and 5% to 20% other pozzolan. Preferably, the materials are selected from mineral ores such as magnesite, brucite, dolomite, bauxite and/or kaolin. Preferably, the mixture includes from 1 to 25% sodium borate decahydrate and 10% to 25% nitrate and or phosphates of ammonia, calcium and/or potassium which have been sequestered with 1% to 5% magnesium distearate salt. Preferably, the activator includes magnesium sulfate, aluminium sulfate, magnesium fluorosilicate, sodium chloride, calcium chloride, ferric chloride, and/or magnesium chloride.

It will be appreciated that the constituents and the activator are comminuted and/or triturated to a size suitable for concrete manufacture. It is believed that the one or more megalithic molecules may be formed by metathesis or the like between the iron oxides and/or silicates constituents and the activator when co-activated by the addition of water to the dry mixture, however, the invention is not necessarily limited to mixtures which undergo such a process.

The iron oxides constituent may be selected from iron ores such as taconite, magnetite, hematite or such like, but may also be selected from mill scale or rust, red mud from bauxite as may be extracted in alumina refining and such like. The iron ores may be selected from lower grade ores than might be required for iron and steel production. Such materials may be calcined if required.

The silicates constituent preferably includes meta zirconium silicate, but may include other pozzolan such as silica fume for example to assist in densifying and/or strengthening the concrete. Other magnesium aluminium silicates may also be included.

In such form that the iron oxides constituent comprises from 20% to 50% by weight of the mixture, it is preferred that the silicates constituent comprises from 10% to 30% meta zirconium silicate and 5% to 20% other pozzolan. The mixture also preferably includes from 5% to 30% magnesium carbonates and oxides (with or without a calcium component) with 10% to 60% aluminium oxides. These materials are preferably selected from mineral ores such as magnesite, talc, brucite, dolomite, bauxite and/or kaolin.

It is believed that there may be benefits in using fly ash for the alumina component due to its properties of fineness and silica content. The UBC (unburnt carbon) content of fly ash, such as that which may be found in “bottom” fly ash may also provide an advantage in strength and/or density of the concrete formed in accordance with the invention. Other magnesium aluminium silicates may be sourced such as from other waste streams and/or different ore bodies and added to or provided with the mixture in appropriate component proportions.

In a further preferred form, the mixture includes from 1 to 25% sodium borate decahydrate and 10% to 25% nitrate and or phosphates of ammonia, calcium and/or potassium which have been sequestered with 1% to 5% magnesium distearate salt. Other metal stearates may also be used, and it will be appreciated that different metal stearates would likely have different sequestering effects.

The activator may include magnesium sulfate, aluminium sulfate, magnesium fluorosilicate, sodium chloride, calcium chloride, ferric chloride, and/or magnesium chloride. A reaction retarding agent such as oxalic acid, tartaric acid and or sodium tetraborate may also be included for slowing down the setting of the concrete. Retarding agents may also be selected from naphthalene and melamine sulfonate superplasticisers. Wetting and/or plasticising may also be achieved by including acrylic acid polycarbonate based superplasticisers.

### BRIEF DESCRIPTION OF THE EXAMPLES

In order that the invention may be more readily understood and put into practical effect, reference will now be made examples which illustrate the invention in one or more preferred forms. In the examples, cementitious mixtures not based on calcium were tested. However, small proportions of lime could be tolerated as a contaminant, or limestone could be used as an aggregate extender. There were two types of limestone free cementitious mixtures—iron oxide based and silicate based. There were two methods of production—batching pre-processed metal oxides or calcining and crushing. There were three alternative methods of activation based on the selected activator—phosphate, sulfate or chloride.

### DETAILED DESCRIPTION OF THE EXAMPLES

### Example Set 1

### Iron Oxide Cementitious Mixtures

A first example in this set was formulated using the following constituents:
Fe as filings and powdered metallic iron;
Fe₃O₄ as iron ore (magnetite) and waste stream mill scale;
Fe₂O₃ as iron ore (hematite) and industrial waste streams;
Fe₃PO₄ as ferric orthophosphate;
FeCl₃ as iron trichloride;
ZrSiO₂ as waste stream amorphous zirconium silicate;
SiO₂ as crushed silica and/or (amorphous) silica fume;
Al₂O₃ as bauxite¹, dolomite², kaolin³ and waste stream fly ash⁴ (bottom ash is suitable);
H₃PO₄ as mono potassium dihydrogen phosphate^{̂1}, ammonium dihydrogen phosphate^{̂2}, aluminium phosphate^{̂3}, sodium diphosphate^{̂4}, zinc phosphate^{̂5}, zirconium phosphate^{̂6} ferric orthophosphate^{̂7} and phosphate rock^{̂8};
H₂SO₄ as aluminium sulfate¹, diammonium sulfate², and ferrous sulfate heptahydrate³;
H₂CO₃ as sodium bicarbonate or potassium bicarbonate;
COOHCOOH as ethanedioic (oxalic) acid;
COOHCH(OH)CH(OH)COOH as tartaric acid;
MgO as magnesite*¹, calcined MgO*², dead burnt MgO*³ and electro-fused MgO*⁴;
MgSiF₆ as magnesium hexafluorosilicate hexahydrate;
Mg(C₁₈H₃₅O₂)₂ as octadecanoic magnesium stearic acid;
MgCl₂ magnesium dichloride hexahydrate; and
Na₂B₄O₇ as sodium tetraborate decahydrate.

Set Time Control

Combinations of the four stages of magnesium oxide are used to control set speed and help develop high early strength in much the same way that the combination of CaSO₄ and C3A activate calcium based cements. Magnesium carbonate, caustic magnesia or calcined magnesium cause the set to commence within 30 seconds to 5 minutes. Dead burnt magnesium extends the set time from 30 minutes to 4 hours. Electro-fused magnesium or part thereof controls set times between 5 minutes and 30 minutes.

Activator

A catalyst or initiator is required to stimulate a reaction required (typically exothermic) to produce polymerisation, gelling and/or crystallisation that resulted in the material forming a hard monolithic mass. For the same reason that gypsum is added to calcium cement, the cement of the example may be initiated with a combination of MgO, ZnO or PbO and KPO₄, NHPO₄, Al₂(SO₄)₃, MgCl₂, FePO₄, FeCl₃, NaBO₄.

Cohesion/Rheology Modifiers

Further set time extenders include Na₂B₄O₇, MgSiF₆, H₂C₂O₄ and C₄H₆O₆ but these components also change cohesive and rheological properties and can be formulated to suit various applications.

The cohesion/rheology modifiers can be provided in the following ranges (by weight):

Na₂B₄O₇—0 to 25;%

MgSiF₆—0 to 25%;

H₂C₂O₄—0 to 10%;

C₄H₆O₆—0 to 10%.

Based on the above criteria, a series of “iron cement” formulations were tested, each test being allocated a test number as “Fe8-XXa” where “XX” refers to the test number, and “a” refers to the kind of initiator used where “p” refers to phosphate, “s” refers to sulfate, and “c” refers to chloride. The tests are set out hereunder.

Fe8-00p

Ingredients:

| Constituent | Content (% by weight) | % Latitude |
|---|---|---|
| Fe₃O₄ | 35 | 0 to 75 |
| Fe₂O₃ | 0 | 0 to 75 |
| Fe | 0.5 | 0 to 5 |
| SiO₂ | 2 | 0 to 25 |
| ⁴Al₂O₃ | 10 | 5 to 50 |
| \hat{ }¹HPO₄ | 15 | 0 to 35 |
| \hat{ }⁷HPO₄ | 3 | 0 to 35 |
| *³MgO | 18 | 0 to 50 |
| *⁴MgO | 4.5 | 0 to 50 |
| MgSiF₆ | 0.4 | 0 to 5 |
| Mg(C₁₈H₃₅O₂)₂ | 0.6 | 0 to 5 |
| Na₂B₄O₇ | 2 | 0 to 10 |
| ZrSiO₂ | 9 | 0 to 50 |
| TOTAL | 100 | |

Method:

An 0.01 g resolution balance was used to measure the dry components into a mixing beaker. A wooden spatula was used to mix water in with the dry ingredients until the mix became plastic. The mixture was then stirred for a further 3 minutes.

The contents of the beaker were transferred into a mould and allowed to set hard to form an iron cement test piece “Fe8-00p” for a period of 4 hours before being demoulded.

Result:

Within the first 15 minutes, gelling had commenced and a small amount of heat was noted due to the accelerated setting caused by the (replaceable) percentage of MgO*⁴

During an observation period of 3 days, the test piece “Fe8-00p” gained very high strength, and demonstrated very high magnetic attraction. No shrinkage was noted.

Conclusion

With the ability to control the set speed of this cement, it should be possible to produce extreme strength concrete with short optimum strength times. Other properties such as waterproof, sulfate and chloride resistance are further enhanced by the very high achievable density.

Fe₃O₄ (magnetite) can be replaced by Fe₂O₃ (hematite) but it was found that a small percentage of Fe (iron) helps to densify the set structure. The percentage range is 0 to 5%.

Tests

The following formulae have been reduced to the reactive ingredients and have been carried out for the purpose of determining the latitude of quantities (+& −) that achieve a solidification reaction while still retaining the properties of the original purpose. It is also noted that solidification occurs outside the claimed parameters, but would only be suitable for solidification of waste sludge such as paint or other polymer clay based industrial waste.

Fe8-01p Low Iron and Low Initiator

Ingredients:

| Constituent | Content (% by weight) |
|---|---|
| Fe₃O₄ | 20 |
| Al₂O₃ | 60 |
| \hat{ }¹HPO₄ | 10 |
| MgO | 10 |
| TOTAL | 100 |

Method:

An 0.01 g resolution balance was used to measure the dry components into a mixing beaker. A wooden spatula was used to mix water in with the dry ingredients until the mix became plastic and then the mixture was stirred for a further 3 minutes.

The contents of the beaker were transferred into a mould and allowed to set hard for a period of 4 hours before being demoulded.

Result:

Extra water had to be added to compensate the absorption of the fly ash, but no bleed was noted. No exothermic heat was noticed during the setting. During the next 3 days, “test Fe8-01p” remained in a low but slowly gaining strength state, and demonstrated slight magnetic attraction.

Conclusion:

AlSiO₂ in the form of fly ash, is an excellent pozzolan that is capable of becoming a cement component when blended with other cement forming ingredients. While this material demonstrates utility in cementitious mixtures of the present invention, it should be appreciated that its inclusion increases water requirements and subsequently develops lower strength when used in higher ratio to the iron oxide component. This issue may be addressed with the use of a suitable plasticiser such as a carboxylated acrylic copolymer that produces steric repulsion, rather than electrostatic repulsion as produced by sulfonated condensates.

Fe8-02p High Iron and Low Initiator

Ingredients:

| Constituent | Content (% by weight) |
|---|---|
| Fe₃O₄ | 60 |
| \hat{ }¹Al₂O₃ | 20 |
| HPO₄ | 10 |
| MgO | 10 |
| TOTAL | 100 |

Method:

An 0.01 g resolution balance was used to measure the dry components into a mixing beaker. A wooden spatula was used to mix water in with the dry ingredients until the mix became plastic. The mixture was then stirred for a further 3 minutes.

The contents of the beaker were transferred into a mould and allowed to set hard for a period of 4 hours before being demoulded.

Result:

No heat became obvious during setting. During the three-day observation, “test Fe8-02p” maintained low strength state for the first day, then appeared to gain strength rapidly over then next two days and demonstrated very high magnetic attraction. The surface appeared to be slightly dusty, indicating there was more Fe₃O₄ then could react before the initial set.

Conclusion:

Fe₃O₄ is an effective cement forming component, but requires a greater quantity of the combined initiator HPO₄ and MgO if the gel time requirement is shorter than 15 minutes.

Fe8-03s Iron with a Sulfate Initiator

Ingredients:

| Constituent | Content (% by weight) | % Latitude |
|---|---|---|
| Fe₃O₄ | 40 | 15 to 75 |
| Fe | 0 | 0 to 5 |
| SiO₂ | 0 | 0 to 25 |
| Al₂O₃ | 10 | 5 to 50 |
| \hat{ }³HPO₄ | 3 | 0 to 35 |
| ¹H₂SO₄ | 15 | 0 to 25 |
| ³H₂SO₄ | 2 | 0 to 35 |
| *³MgO | 30 | 10 to 75 |
| MgSiF₆ | 0 | 0 to 5 |
| ²Mg(C₁₈H₃₅O₂) | 0 | 0 to 5 |
| Na₂B₄O₇•10H₂O | 0 | 0 to 10 |
| ZrSiO₂ | 0 | 0 to 50 |
| TOTAL | 100 | |

Method:

An 0.01 g resolution balance was used to measure the dry components into a mixing beaker. A wooden spatula was used to mix water in with the dry ingredients until the mix became plastic. The mixture was then stirred for a further 3 minutes.

The contents of the beaker were transferred into a mould and allowed to set hard for a period of 4 hours before being demoulded.

Result:

“Test Fe8-03s” gelled in 10 minutes and set very quickly with slight but noticeable exothermic heat. High strength was apparent within a few hours and high magnetic attraction was demonstrated.

Conclusion:

Sulfates work as effectively to initiate a set as phosphates. Control in set time was not determined, however the strength and magnetic attraction were still very high. (There was also an indication that external sulfates in the form of gas or aqueous solution contact may strengthen or case-harden a compound or concrete made from this cement.)

### Example Set 2

### Zirconium Silicate Cementitious Mixtures

The cement based on zirconium silicate was found to posses exceptionally high refractory qualities, as well as very high bond, flexural and compressive strengths.

Uses would include, for example, furnace and firebox linings. Due to a high resistance to acid, the cement could be foamed and used as an intermediate insulation layer as well as a hard face layer in furnace linings. It can also be reinforced with carbon fibre and used as fire proof thin section cowling or panels for machinery, burners, work platforms, etc.
a. batching pre-processed metal oxide as indicated in the following formulae or
b. manufactured in a similar process to limestone based cements by calcining the components and crushing them together.

Crushing would provide a greater fineness or greater surface area, making a more effective binder. The calcining of a phosphate usually produces a more reactive pyrophosphate. Formulators can choose to include phosphate during calcining or add later during the crushing phase. To reduce the likelihood of hygroscopic reaction in storage, Mg(C₁₈H₃₅O₂)₂ octadecanoic magnesium stearic acid is added. This also increases cohesion and workability.

Zirconium Silicate Cement Test Formulae

Based on the above criteria, a series of “zircon silicate cement” formulations were tested, each test being allocated a test number as “Zrx-XXa” where “x” is a number referring to a subset within the series, “XX” refers to the test number, and “a” refers to the kind of initiator used where “p” refers to phosphate, “pp” refers to phosphate-pyrophosphate, “s” refers to sulfate, and “c” refers to chloride. The tests are set out hereunder.

Zr3-00p

Ingredients:

| Constituents | Content (% by weight) | % Latitude |
|---|---|---|
| Fe₃O₄ | 0 | 0 to 15 |
| Fe | 0 | 0 |
| SiO₂ | 0 | 0 to 25 |
| Al₂O₃ | 10 | 5 to 50 |
| \hat{ }¹HPO₄ | 15.5 | 10 to 35 |
| *³MgO | 25 | 0 to 50 |
| *⁴MgO | 6.5 | 0 to 50 |
| MgSiF₆ | 1 | 0 to 5 |
| Mg(C₁₈H₃₅O₂)₂ | 0 | 0 to 5 |
| Na₂B₄O₇•10H₂O | 2 | 0 to 10 |
| ZrSiO₂ | 40 | 15 to 75 |
| TOTAL | 100 | |

Method:

An 0.01 g resolution balance was used to measure the dry components into a mixing beaker. A wooden spatula was used to mix in water with the dry ingredients until the mix became plastic. The mix was then stirred for a further 3 minutes.

The contents of the beaker were transferred into a mould and allowed to set hard for a period of 4 hours before being demoulded.

Result:

Within the first 15 minutes gelling had commenced and a small amount of exothermic heat was noted due to the accelerated setting caused by the (replaceable) percentage of MgO*⁴. Over the 3-day observation period, “test Zr3-00a” gained very high strength.

Conclusion:

With the ability to control the set speed of this cement, it should be possible to produce extreme strength concrete with short optimum high early strength times. As well as other properties such as being refractory and waterproof, it is also sulphate and chloride resistance, enhanced by the very high achievable density.

Zr5-00pp Foam

Ingredients:

| Constituents | Content (% by weight) | % Latitude |
|---|---|---|
| Fe₃O₄ | 0 | 0 to 15 |
| Fe | 0 | 0 |
| SiO₂ | 0 | 0 to 35 |
| Al₂O₃ | 25 | 5 to 50 |
| \hat{ }¹HPO₄ | 15.5 | 0 to 35 |
| HPO₄ (** K₄P₂O₇ (pyro)) | 3 | 0 to 35 |
| *³MgO | 26.5 | 0 to 50 |
| *⁴MgO | 3 | 0 to 50 |
| MgSiF₆ | 0 | 0 to 20 |
| Mg(C₁₈H₃₅O₂)₂ | 0 | 0 to 5 |
| NaHCO₃ | 2 | 1 to 10 |
| ZrSiO₂ | 25 | 15 to 75 |
| TOTAL | 100 | |

plus

Fe9-00pp Foam

Ingredients:

| Constituents | Content (% by weight) | % Latitude |
|---|---|---|
| Fe₃O₄ | 35 | 17 to 75 |
| Fe | 0 | 0 to 5 |
| SiO₂ | 0 | 0 to 35 |
| Al₂O₃ | 25 | 5 to 50 |
| *³\hat{ }¹HPO₄ | 15.5 | 0 to 35 |
| HPO₄ (K₄P₂O₇ (pyro)) | 3 | 0 to 35 |
| MgO | 16.5 | 0 to 50 |
| *⁴MgO | 3 | 0 to 50 |
| MgSiF₆ | 0 | 0 to 20 |
| Mg(C₁₈H₃₅O₂)₂ | 0 | 0 to 5 |
| NaHCO₃ | 2 | 1 to 10 |
| ZrSiO₂ | 0 | 0 to 50 |
| TOTAL | 100 | |

Method:

An 0.01 g resolution balance was used to measure the dry components for each mixture into a separate mixing beaker. A wooden spatula was used to mix water in with the dry ingredients until in each case the mix became sufficiently fluid to cast. Each mixture was then stirred for a further 60 seconds.

The content of each beaker was transferred into a different mould and allowed to set hard for a period of 4 hours before being demoulded.

Result:

Identical reaction in “test Zr5-00pp and Fe9-00pp” as the mixture was observed to slowly rise within 2 minutes of casting. Gelling occurred in 10 minutes, slight exothermic heat was noted until completely set at about 40 minutes. The aeration substantially reduced the density of the sample, however both samples still maintained high strength.

Conclusion:

Due to the very high refractoriness and adhesive nature of the zirconium silicate foamed cement, it would be useful as a fireproof spray applied insulation. Iron-based foamed cement according to the invention also has high strength properties, but may only be suitable for applications requiring refractory properties below about 800° C. due to the melting temperature of iron. It would also be useful for the manufacture of aerated concrete blocks and panels, without the necessity to autoclave.

Cementitious mixtures according to the invention may be used as an alternative to general purpose cement (Ordinary Portland Cement—OPC) used for concrete as well as special applications to utilize unique properties. For example, use may typically be for mining, civil and building construction. Specifically, applications could include, for example, below ground and underwater structure, foundations, footings, and pylons, as well as in extreme chemical and gas environments such as, for example, fuel cells, sewage treatment plants and abattoirs. The cementitious mixture may also have application in respect of industrial flooring and pavements where high magnetic attraction and low electrical potential is a requirement. New development for temporary machine anchoring, including horizontal and vertical robotic movement will be possible with the Iron Cement.

Suitable for fibre reinforced extrusion, capable of being pressed to any thin wall shape. Glass reinforced concrete application may benefit as the requirement for “alkaline resistant” glass fibre is eliminated. Due to its cohesive, high bonding nature this cement will prove suitable for spray (shotcrete-gunite) applications.

Although the invention has been described with reference to specific examples, it will be appreciated by those skilled in the art that the invention may be embodied in other forms and combinations thereof within the broad scope and ambit of the invention as herein set forth.

1-27. (canceled)

28. A lime independent cementitious mixture including:
an iron oxides constituent comprising one or more oxides of iron; and
an activator selected from a first set of activators comprising:
one or more metal non-chloride, non-oxychloride salts; or
one or more non-alkaline earth metal salts and one or more magnesium and ammonium non-chloride salts;
which may form one or more megalithic molecules with the iron oxides constituent when co-activated with water.

29. A lime independent cementitious mixture including:
an iron oxides constituent comprising one or more oxides of iron; and
a silicates constituent comprising one or more calcined metal silicates; and an activator selected from a second set of activators comprising:
one or more metal salts; or
one or more metal non-chloride salts; or
one or more non-alkaline earth metal salts; or
one or more non-alkaline earth metal salts and one or more non-chloride salts;
which may form one or more megalithic molecules with the iron oxides constituent when co-activated with water.

30. The lime independent cementitious mixture according to claim 29, wherein the non-chloride salts are selected from magnesium and aluminium non-chloride salts.

31. The cementitious mixture according to claim 28, wherein the iron oxides constituent is selected from iron ores including taconite, magnetite and hematite and from mill scale, mill rust, and red mud from bauxite.

32. The cementitious mixture according to claim 29, wherein the iron oxides constituent is selected from iron ores including taconite, magnetite and hematite and from mill scale, mill rust, and red mud from bauxite.

33. The cementitious mixture according to claim 28, wherein the iron oxides constituent is calcined.

34. The cementitious mixture according to claim 29, wherein the iron oxides constituent is calcined.

35. The cementitious mixture according to claim 28, wherein the iron oxides constituent comprises from 20% to 50% by weight of the mixture.

36. The cementitious mixture according to claim 29, wherein the iron oxides constituent comprises from 20% to 50% by weight of the mixture.

37. The lime independent cementitious mixture including:
a silicates constituent comprising one or more calcined metal silicates; and
an activator selected from one or more non-alkaline earth metal salts and one or more magnesium and ammonium non-chloride salts which may form one or more megalithic molecules with silicates constituent when co-activated with water.

38. The cementitious mixture according to claim 37, wherein the silicates constituent includes meta zirconium silicate.

39. The cementitious mixture according claim 37, wherein the silicates constituent includes magnesium aluminium silicates.

40. The cementitious mixture according to claim 28, and including from 5% to 30% magnesium carbonates and oxides (with or without a calcium component) with 10% to 60% aluminium oxides.

41. The cementitious mixture according to claim 29, and including from 5% to 30% magnesium carbonates and oxides (with or without a calcium component) with 10% to 60% aluminium oxides.

42. The cementitious mixture according to claim 41, wherein the silicates constituent comprises from 10% to 30% meta zirconium silicate and 5% to 20% other pozzolan.

43. The cementitious mixture according to claim 42, wherein the materials are selected from mineral ores including magnesite, brucite, dolomite, bauxite and/or kaolin.

44. The cementitious mixture according to claim 43, wherein the mixture includes from 1 to 25% sodium borate decahydrate and 10% to 25% nitrate and or phosphates of ammonia, calcium and/or potassium which have been sequestered with 1% to 5% magnesium distearate salt.

45. The cementitious mixture according to claim 28, wherein the activator includes magnesium sulfate, aluminium sulfate, magnesium fluorosilicate, sodium chloride, calcium chloride, ferric chloride, and/or magnesium chloride.

46. The cementitious mixture according to claim 29, wherein the activator includes magnesium sulfate, aluminium sulfate, magnesium fluorosilicate, sodium chloride, calcium chloride, ferric chloride, and/or magnesium chloride.

47. The method of forming a lime independent cementitious mixture including:
providing an iron oxides constituent comprising one or more oxides of iron; and
mixing the iron oxides constituent with an activator selected from one or more metal non-chloride, non-oxychloride salts which may form one or more megalithic molecules with the iron oxides constituent when co-activated with water.

48. The method of forming a lime independent cementitious mixture including:
providing an iron oxides constituent comprising one or more oxides of iron and a silicates constituent comprising one or more calcined metal silicates; and
mixing the iron oxides and silicates constituents with an activator selected from one or more metal salts which may form one or more megalithic molecules with the iron oxides and/or silicates constituents when co-activated with water.
